(19) United States
(12) Patent Application Publication
(10) Pub. No.: US 2022/0209589 A1
(43) Pub. Date: Jun. 30, 2022

(54) Claw Pole Stator for a Transverse Flux Machine

(71) Applicant: GKN Sinter Metals Engineering GmbH, Radevormwald (DE)

(72) Inventors: Stefan Tiller, Sankt Augustin (DE); Hong Giang To, Düsseldorf (DE); Wilhelm Montsch, Wachtberg (DE)

(21) Appl. No.: 17/439,335

(22) PCT Filed: Mar. 19, 2020
(86) PCT No.: PCT/EP2020/057604

§ 371 Date: Sep. 14, 2021

(30) Foreign Application Priority Data
Mar. 20, 2019 (DE) 10 2019 107 136.4

(51) Int. Cl. H02K 1/14; H02K 21/14

(52) U.S. Cl. CPC H02K 1/145; H02K 2201/12; H02K 21/145

(57) ABSTRACT

The invention relates to a claw pole stator (1) for a transverse flux machine (2). The claw pole stator (1) is made of a plurality of segments (3) that are arranged next to one another along a circumferential direction (4) so as to form the annular claw pole stator (1). Each segment (3) extends from an inner circumferential surface (5) along a radial direction (6) to an outer circumferential surface (7) and is delimited by a first lateral surface (8) and a second lateral surface (9) in the circumferential direction (4) and by a first end surface (11) and a second end surface (12) in an axial direction (10). Each segment (3) is connected to additional segments (3) via the lateral surfaces (8, 9) in order to form the annular claw pole stator (1), and adjacent segments (3) contact one another via a first contact surface (13) on the first lateral surface (8) or via a second contact surface (14) on the second lateral surface (9) and form a connection (15) which is interlocking in the circumferential direction (4) via the contact surfaces (13, 14).

The invention relates to a claw pole stator for a transverse flux machine. Transverse flux machines are electric drives which can be used as a generator and as a motor. Transverse flux machines typically comprise a stator and a rotor. The rotor here is referred to as the carrier of permanent magnets while the stator has a coil assembly. The rotor or the stator can be connected to a shaft which is driven by the transverse flux machine (operation as a motor) or transmits a rotating movement to the transverse flux machine (operation as a generator).

An electric axial flux machine is known from DE 10 2009 021 703 B4, for example. It is inter alia proposed there to form the magnet flux yokes from a plurality of annular cylindrical segments. The annular cylindrical segments contact one another by way of lateral faces that point in the circumferential direction.

It is particularly advantageous for claw pole stators to be produced by powder metallurgy. To this end, a powder with a predetermined composition is fed to a press and compressed. A subsequent heat treatment serves for removing organic component parts. The powder particles comprise in particular electrically isolating coatings. High-precision components can be generated by the powder metallurgical production.

Segments for a claw pole stator that have been produced in a particularly advantageous manner are known from WO 2018/166858 A1. The segments here can in each case be produced with high precision so that an exact mutual fit of the individual segments can be guaranteed. The mutual disposal of the segments, which is almost devoid of any gap, enables the operation of a transverse flux machine with high efficiency because the magnetic flux can be transmitted without a gap between the segments. The assembling of at least 10, or rather more than 20 or more, segments so as to form an annular stator likewise requires high precision in the individual segments.

It has now been demonstrated that the assembling of segments of this type so as to form an annular claw pole stator is fraught with difficulty. By virtue of the precise fit required, the individual segments are particularly difficult to join to one another; and the completely formed claw pole stator can be disposed, for example on a stator carrier, only with difficulty because the stator formed from segments is substantially rigid, on the other hand.

Proceeding therefrom it is an object of the present invention to at least partially solve the issues described in the context of the prior art. A claw pole stator which is suitable for production by powder metallurgy and is easier to assemble, or to mount, respectively, is in particular to be proposed.

In order for this object to be achieved, a claw pole stator according to the features of claim 1 is proposed. Advantageous embodiments are the subject matter of the dependent claims. The features individually set forth in the claims can be combined with one another in a technologically expedient manner and can be enhanced by explanatory facts from the description and by details from the figures, wherein further variants of embodiments of the invention are demonstrated.

Contributing toward this end is a claw pole stator for a transverse flux machine, wherein the claw pole stator is formed by a multiplicity of segments which are disposed next to one another along a circumferential direction (or form the annular claw pole stator, respectively). Each segment, proceeding from an internal circumferential face, along a radial direction extends to an external circumferential face and in the circumferential direction is delimited by a first lateral face and a second lateral face, and in an axial direction is delimited by a first end face and a second end face. Each segment by way of the lateral faces is connected to at least one further segment (for forming the annular claw pole stator), wherein segments disposed so as to be mutually adjacent contact one another by way of a first contact face of the first lateral face or by way of a second contact face of the second lateral face of the respective segment and by way of the contact faces configure a connection which is form-fitting in the circumferential direction and in the radial direction. A first clearance of the connection, present in (or in relation to, respectively) the circumferential direction, is larger than a second clearance of the connection, present in (or in relation to, respectively) the radial direction.

A “clearance” here defines in particular a dimension of a (potential) mutual relative displacement of two components in the specific direction (first clearance: in the circumferential direction; second clearance: in the radial direction).

A first segment contacts a second segment disposed so as to be adjacent thereto in particular by way of the first contact face or the second contact face of the latter. If both segments are mutually identical, the first segment can contact the second segment (immediately or directly, respectively) by way of the first contact face of the former and by way of the second contact face of the latter.

A segmentation of the claw pole stator however leads to the issue of joining the segments so as to form the annular claw pole stator. On the one hand, easy handling of the segments is to be enabled here and an ideally precise mutual positioning of the segments is to be able to be achieved, on the other hand. Until now, both requirements have been able to be achieved or guaranteed, respectively, by configuring connections between segments disposed so as to be adjacent, said connections being form-fitting in the circumferential direction. It has been demonstrated that high-precision segments may potentially lead to more problematic assembling.

It is therefore proposed here that a clearance in the form-fitting connection is provided in particular only in one of the directions (here: a clearance in relation to the circumferential direction).

Form-fitting connections are created by the mutual engagement of at least two connecting partners (here: the segments). As a result thereof, the connecting partners cannot be released even in the absence or an interruption of a transmission of force. In other words, in the case of a form-fitting connection, one of the connecting partners obstructs the other (here: in relation to a mutual relative movement in the circumferential direction and in the radial direction). Here, the form-fitting connection is established, or released again, respectively, by relatively displacing two segments along the axial direction.

The individual segments by way of the form-fitting connections can be assembled so as to form the annular claw pole stator. The segments can in particular be disposed on a carrier member which mutually aligns the segments at least across the internal circumferential face thereof or the external circumferential face thereof, or holds said segments so as to be mutually aligned at least across the internal circumferential face thereof or the external circumferential face thereof, respectively. The segments are then preferably connected to one another, for example by way of a second material (for example an adhesive) which is fed to the claw pole stator in the liquid state, for example, and then solidifies.

The construction of a claw pole stator will be explained hereunder. Two claw pole stators are disposed next to one another along the axial direction, wherein said two claw pole stators contact one another by way of the end faces. Each claw pole stator has a multiplicity of poles which, proceeding from a base area, extend along the axial direction. First poles of the first claw pole stator and second poles of the second claw pole stator are disposed in an alternating manner and in each case mutually adjacent along the circumferential direction, and disposed so as to mutually overlap but be mutually spaced apart in the axial direction. The poles can be disposed on the internal circumferential face or on the external circumferential face. The claw pole stators in this instance contact one another by way of the end faces on the external circumferential face or on the internal circumferential face. In the internal space of the claw pole stators, in the axial direction between the end faces and in the radial direction between the mutually contacting end faces and the poles, a coil can be disposed so as to be encircling in the circumferential direction between the claw pole stators. A disposal of further pairs of claw pole stators with coils on the first pair is likewise possible. As a result, multi-phased transverse flux machines can be formed, for example. A transverse flux machine can in particular provide electrical outputs of 0.01 kW [kilowatt] to more than 5000 kW.

Positioning aids which interact with corresponding positioning aids (for example, elevations or depressions) on the opposite end faces can be provided on the end faces of the claw pole stators.

At least one of the contact faces extends in particular so as to meander between a first radius and a second radius along the radial direction. “Meandering” means in particular by way of a curvature, in particular curvature radii which are oriented so as to alternate in relation to the radial direction. The profile can be “meandering” when the contact face extends on both sides of an imaginary line that is centric, or central, respectively, to the profile of the contact face and parallel to the radial direction.

The poles in the radial direction are in particular disposed outside or within the contact face.

One contact face is provided on each lateral face of the segment. The contact face comprises at least a partial face of the lateral face. The contact face extends in each case in particular across the entire extent of the lateral face along the axial direction. The contact face extends preferably only across part of the extent of the lateral face along the radial direction.

The contact face extends so as to meander along the radial direction, wherein the form-fitting connection to a segment disposed so as to be adjacent is formed as a result of the meandering shape of the contact face.

Such a meandering profile (having a sharp edge here) of the contact face is realized, for example, by the contact faces being embodied as dovetails.

At least one of the contact faces along the meandering profile preferably has a smallest curvature radius of at least 1.0 mm [millimeters], preferably of at least 2.0 mm. Such a minimum radius reduces the risk of cracks forming in the segment, said cracks potentially arising specifically in the case of an embodiment of a form-fitting connection having sharp edges (for example, a dovetail).

The at least one contact face has in particular an exclusively curved profile along the meandering profile. In particular, no rectilinear regions of the contact face are thus provided in the radial direction. This means that each point of the contact face along the radial direction is formed by a curvature radius (which is variable along the radial direction).

The at least one contact face along the meandering profile preferably extends across a length which is larger than a spacing between the first radius and the second radius along the radial direction by a factor of at least 1.5, in particular by a factor of at least two (2.0). The contact face is thus extended in length (in comparison to a rectilinear profile between the first radius and the second radius along the radial direction) as a result of the meandering profile.

An enlargement of the contact face moreover increases the strength of the joined claw pole stator. The clearance and the mutual relative mobility of the segments is furthermore reduced as a result of the meandering profile and the enlargement of the contact face.

The second clearance is in particular at most 50%, preferably at most 20%, particularly preferably at most 10% of the first clearance.

The first clearance between the adjacent segments enables a mutual relative displacement of the segments along the circumferential direction, in particular by 0.2 to 1.0 millimeters, preferably 0.2 to 0.5 millimeters. The second clearance between the adjacent segments enables a mutual relative displacement of the segments along the radial direction in particular by at most 0.5 millimeters, preferably by at most 0.25 millimeters.

In particular, the second clearance is always present in a constant manner, independently of the mutual position of the segments in terms of the first clearance.

The claw pole stator is in particular configured so as to be encircling in the circumferential direction, and as a largest nominal diameter (thus the largest diameter of the claw pole stator, wherein the nominal dimension as provided in terms of construction for this diameter is considered here) has a largest first diameter, wherein the claw pole stator as a result of the first clearance is deformable such that a largest second diameter of the deformed claw pole stator deviates from the first diameter by at least 2%, preferably at least 5%.

The largest nominal diameter is in particular the largest first diameter of the claw pole stator that has been provided as the nominal dimension. The largest second diameter is achieved when the segments are pulled apart (by the first clearance) or pushed together (by the first clearance). The largest second diameter present in this instance then deviates from the largest first diameter in particular by the stated value, and may thus be smaller or larger than the largest first diameter.

As a result of the segments being pulled apart or pushed together, and of adjusting a second diameter, the annular claw pole stator can be more easily disposed on a stator carrier, for example be pushed on along an axial direction, for example while assembling the claw pole stator or a stator assembly, respectively. The nominal diameter of the claw pole stator upon the push-fitting or the disposing of the latter is then predefined by the stator carrier, for example, on which the claw pole stator is then disposed, optionally without a clearance or a gap, respectively, by varying the first clearance.

The nominal shape of the claw pole stator is in particular circular-annular, thus has a constant internal diameter and external diameter, for example. As a result of the first clearance, this nominal shape can in particular be enlarged when the segments are slid apart such that this results in either an encircling constant larger (second) diameter, or the annular shape can be changed to an oval having a second diameter which locally is even larger, for example. Conversely, the same can be achieved when the segments are pushed together (in this instance having a correspondingly reduced second diameter).

In the proposed disposal of the first clearance (effective in the circumferential direction) and the smaller second clearance (effective in the radial direction) it can in particular be taken into account that only minor gaps between adjacent segments result in those regions that are passed through by the magnetic flux. The profile of the magnetic flux that arises in the operation of the claw pole stator has to be taken into account here.

A contact face in the region of the second clearance runs in particular substantially along the circumferential direction (and in particular substantially parallel to the axial direction) and transversely to the radial direction.

A contact face in the region of the first clearance runs in particular substantially along the radial direction (and in particular substantially parallel to the axial direction) and transversely to the circumferential direction.

The larger first clearance enables in particular that a lower requirement can be set in terms of the tolerance of the segments in the production of the segments. In particular, a tolerance in terms of the circumferential direction can be enlarged in comparison to the tolerance in terms of the radial direction. This results in particular in advantages in the manufacturing of the segments, for example in terms of the costs for the production of the tools, the quality monitoring, the reject rate, etc.

According to a first design embodiment, each segment comprises a plurality of poles.

According to a second design embodiment, each segment has exactly one (single) pole. A particularly compact die of a pressing tool which is used in the production of the segment can be used in the case of segments of this type. Furthermore, additional measures for further homogenizing the density in the pressed part (green compact) can be implemented in a simple and cost-effective manner specifically in this instance.

The segmentation permits the cost-effective and high-precision production of a claw pole stator because the very small segments can be produced with high precision, on the one hand, and the segments can be mutually aligned and disposed in a precise manner by way of a centering installation (for example the stator carrier, thus a carrier member), on the other hand. This high-precision shape of the claw pole stator thus generated can subsequently be established by a setting measure (for example the embedding in a plastics material).

It is in particular proposed that each of the segments is produced by powder metallurgy by pressing and heat-treating.

The claw pole stator is preferably formed exclusively by identically embodied segments. The segments in this instance have first contact faces which conjointly with the second contact faces of an identical segment disposed so as to be adjacent thereto configure the form-fitting connection.

The claw pole stator by way of the external circumferential face or the internal circumferential face of the segments forms in particular a cylindrical contour, wherein a circumferential face of the external circumferential face and the internal circumferential face is formed by the poles of the segments.

Furthermore proposed is a stator assembly, at least comprising the claw pole stator described and a stator carrier, wherein the claw pole stator is disposed on the stator carrier, the latter at least in terms of an internal diameter or an external diameter of the claw pole stator predefining a nominal shape of the claw pole stator.

The nominal shape is the shape of the claw pole stator as provided in terms of construction, thus having zero deviation from the respective nominal dimension provided.

A gap between at least two segments is in particular at least partially filled by an at least electromagnetically conducting first material. Spacings, or gaps, respectively, for example formed by the first clearance (optionally by other dimensions), between two mutually adjacent segments can thus in particular be closed so that only minor electrical losses arise in the operation of the stator assembly.

The first material is in particular an electrically, or electromagnetically, respectively, isolating material.

At least one contact face of at least one segment is in particular embodied so as to be electrically isolating, in particular by way of a coating. The coating, for example in the form of a lacquer, is in particular disposed on the contact face after a production of the segment by powder metallurgy. In particular, each segment is disposed in relation to an adjacent segment by way of at least one electrically isolating contact face of this type. Each segment preferably has at least one electrically isolating contact face. Both contact faces of a segment are particularly preferably embodied so as to be electrically isolating. In particular, all contact faces of all segments are embodied so as to be electrically isolating.

The electrically isolating contact face is particularly implemented already in the production of a segment by powder metallurgy, as a result of the powder particles being provided with an electrically isolating coating. The subsequent coating serves in particular for ensuring this electrically isolating state of the contact face.

The segments are in particular at least partially encompassed by a second material such that a nominal shape of the claw pole stator is set by the second material. The second material during the application is in particular of low-viscosity or liquid such that even small voids in the claw pole stator can be filled by said second material. The second material is in particular not electrically or electromagnetically conductive.

Furthermore proposed is a segment for the claw pole stator described, wherein the segment, proceeding from an internal circumferential face, along a radial direction extends to an external circumferential face, and in the circumferential direction is delimited by a first lateral face and a second lateral face, and in an axial direction is delimited by a first end face and a second end face. The segment by way of the lateral faces is able to be connected to at least one further segment so as to form the (annular) claw pole stator, wherein segments which are able to be disposed so as to be mutually adjacent contact one another by way of a first contact face of the first lateral face or by way of a second contact face of the second lateral face. The contact faces are shaped such that a connection, which is form-fitting in the circumferential direction, to a contact face shaped in a complementary manner of a segment, the latter being able to be disposed so as to be adjacent, is in each case able to be configured by way of the contact faces.

At least one (preferably both) of the contact faces extends/extend in particular so as to be parallel to the axial direction.

A pole of the segment, proceeding from a base area, extends in particular along the axial direction and tapers herein.

The segment is in particular produced by powder metallurgy by pressing and heat-treatment.

Proposed according to a further aspect is a transverse flux machine, at least comprising a stator and a rotor, wherein the stator comprises at least two of the claw pole stators described above, wherein first poles of the first claw pole stator and second poles of the second claw pole stator are disposed in an alternating manner and in each case mutually adjacent along the circumferential direction, and disposed so as to mutually overlap in the axial direction. The claw pole stators here are mutually disposed such that the poles proceeding from the base area extend toward the other claw pole stator along the axial direction.

The axial direction is aligned so as to be parallel to a rotation axis of the transverse flux machine.

The rotor extends in particular in an annular manner and along the circumferential direction has a multiplicity of permanent magnets, wherein an air gap encircling in the circumferential direction is provided between the rotor and the stator.

The explanations pertaining to the claw pole stator apply equally to the segment, the stator assembly and/or the transverse flux machine and vice versa.

The transverse flux machine can be used in particular for electrically operated bicycles (e-bikes).

By way of precaution, it is pointed out that the numerical words used here (“first”, “second”, . . . ) serve primarily (only) for distinction between several similar objects, dimensions or processes, that is to say in particular they do not imperatively predefine a dependency and/or sequence of said objects, dimensions or processes. If a dependency and/or sequence is necessary, this will be explicitly stated here, or will emerge in an obvious manner to a person skilled in the art from a study of the design embodiment being specifically described.

The invention and the technical field will be discussed in more detail below by means of the figures. It is pointed out that the invention is not intended to be restricted by the exemplary embodiments shown. In particular, unless explicitly presented otherwise, it is also possible for partial aspects of the substantive matter discussed in the figures to be extracted and combined with other constituent parts and knowledge from the present description and/or figures. It is in particular to be pointed out that the figures and in particular the size ratios illustrated are only schematic. The same reference signs refer to identical objects, such that, where appropriate, explanations from other figures can be taken into consideration in a supplementary manner. In the figures:

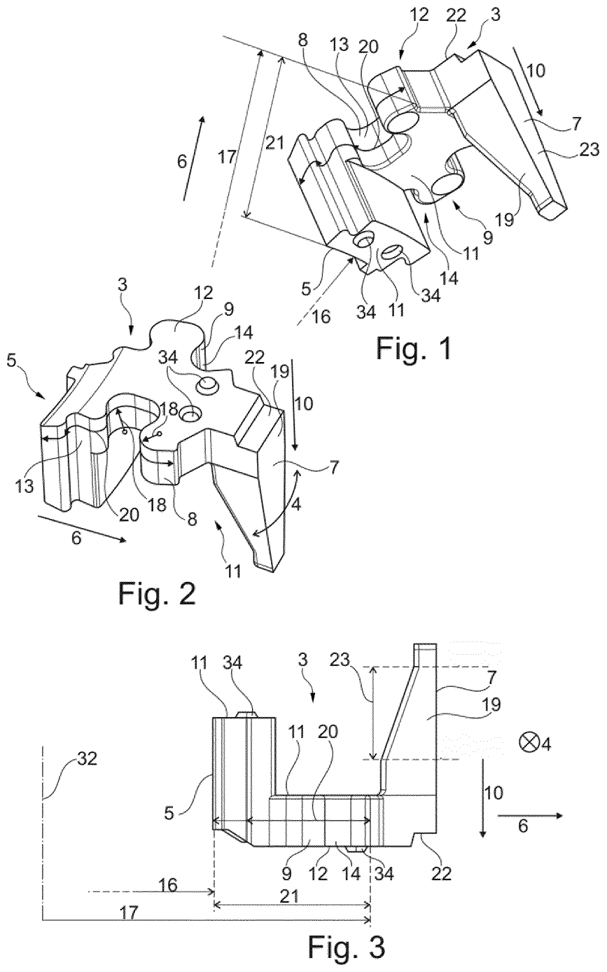

FIG. 1: shows a segment in a first perspective view;

FIG. 2: shows the segment as per FIG. 1 in a second perspective view;

FIG. 3: shows the segment as per FIGS. 1 and 2 in a lateral view;

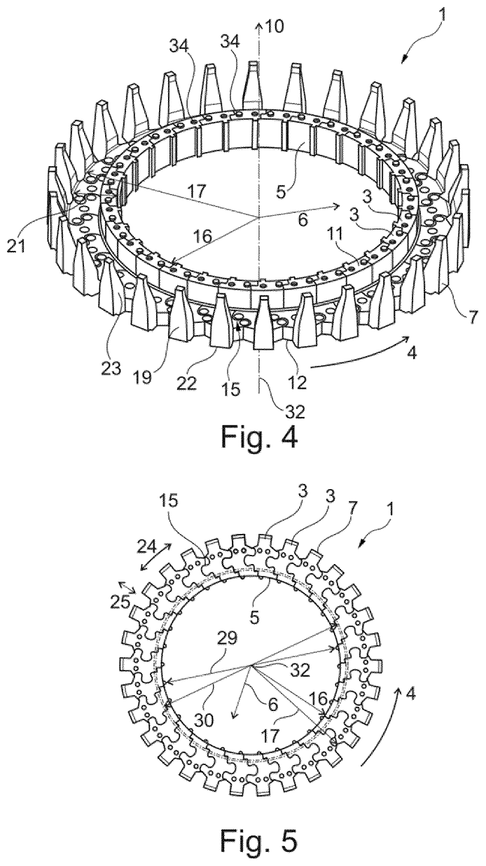

FIG. 4: shows a claw pole stator in a perspective view;

FIG. 5: shows the claw pole stator as per FIG. 4 in a view from below along the axial direction;

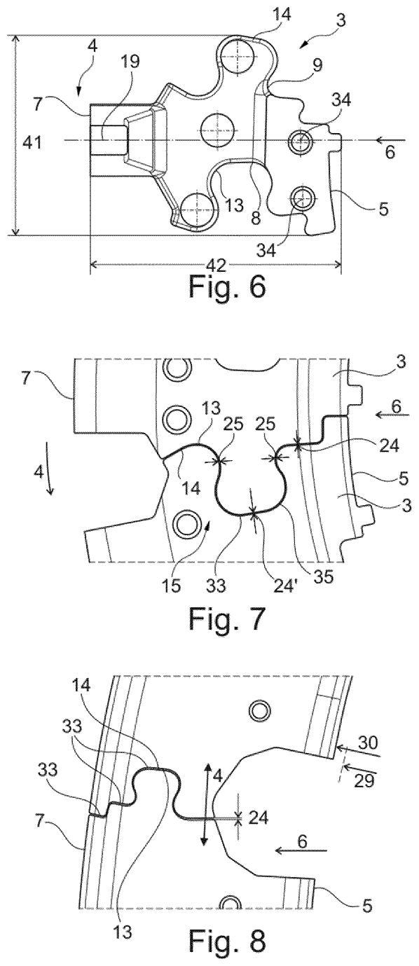

FIG. 6: shows the segment as per FIGS. 1 to 3 in a view from above along the axial direction;

FIG. 7: shows a form-fitting connection of two segments of the claw pole stator as per FIGS. 4 and 5 in a view from below along the axial direction;

FIG. 8: shows a form-fitting connection of two segments of another claw pole stator in a view from below along the axial direction;

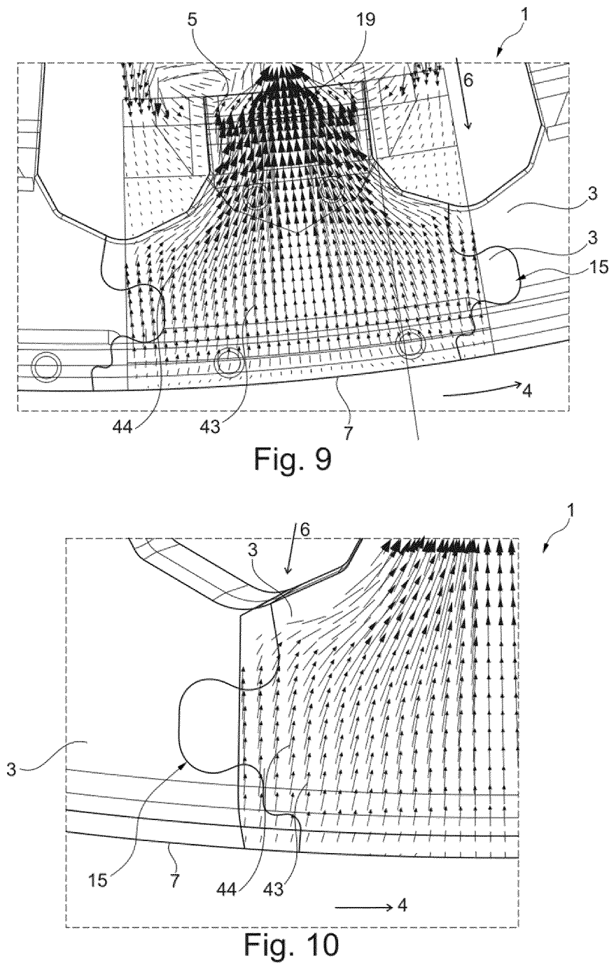

FIG. 9: shows an illustration of a magnetic flux through a fragment of a claw pole stator as per FIG. 8 in a view of the claw pole stator from below along the axial direction;

FIG. 10: shows a detail of FIG. 9;

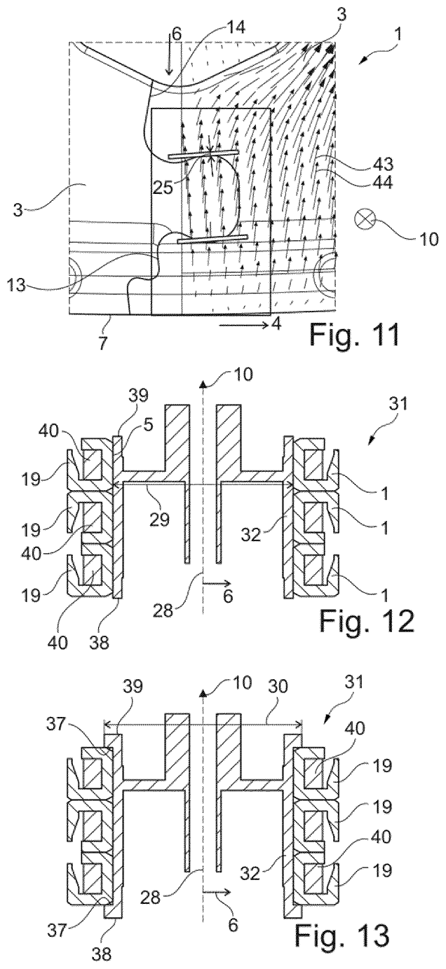

FIG. 11: shows a detail of FIG. 10;

FIG. 12: shows a sectional illustration of a first variant of embodiment of a stator assembly in a lateral view;

FIG. 13: shows a sectional illustration of a second variant of embodiment of a stator assembly in a lateral view;

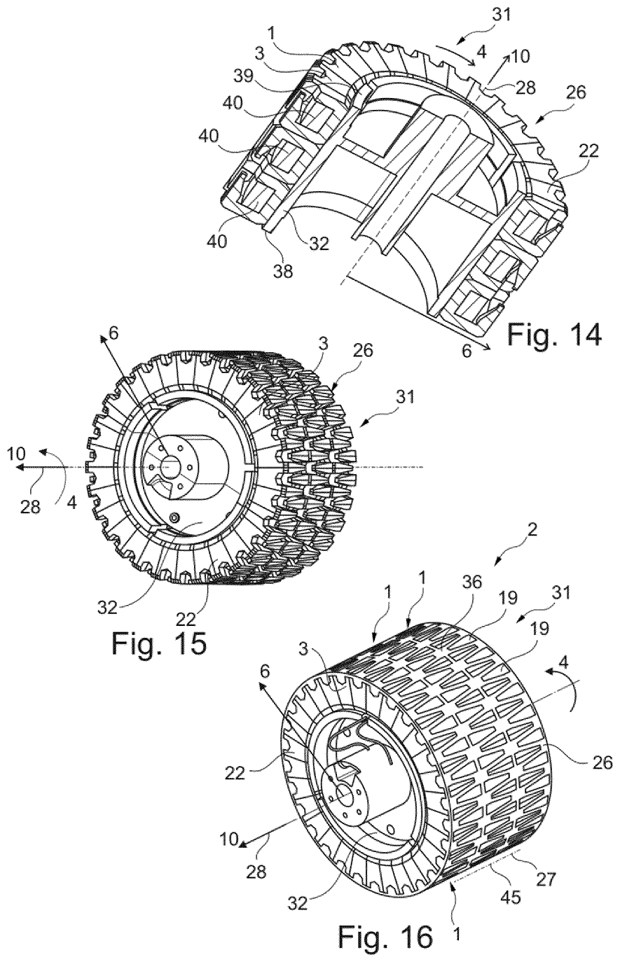

FIG. 14: shows the stator assembly as per FIG. 12 in a perspective sectional view;

FIG. 15: shows the stator assembly as per FIGS. 12 and 14 in a perspective view; and

FIG. 16: shows the stator assembly as per FIGS. 12, 14 and 15, here having a second material, in a perspective view.

FIG. 1 shows a segment 3 in a first perspective view. FIG. 2 shows the segment 3 as per FIG. 1 in a second perspective view. FIG. 3 shows a segment 3 as per FIGS. 1 and 2 in a lateral view. FIGS. 1 to 3 will be conjointly described hereunder.

The segment 3, proceeding from an internal circumferential face 5, along a radial direction 6 extends to an external circumferential face 7 and in the circumferential direction 4 is delimited by a first lateral face 8 and a second lateral face 9, and in an axial direction 10 is delimited by a first end face 11 and a second end face 12. The segment 3 by way of the lateral faces 11 is able to be connected to further segments 3 so as to form the annular claw pole stator 1, wherein segments 3 disposed so as to be mutually adjacent contact one another by way of a first contact face 13 of the first lateral face 8 or by way of a second contact face 14 of the second lateral face 9. The contact faces 13, 14 are shaped such that a connection 15, which is form-fitting in the circumferential direction 4, to a contact face 14, 13 shaped in a complementary manner of a segment 3 which is able to be disposed so as to be adjacent is able to be configured by way of the contact faces 13, 14. Both contact faces 13, 14 extend so as to be parallel to the axial direction 10.

A pole 19 of the segment 3, proceeding from a base area 22, extends along the axial direction 10 and tapers herein.

Positioning aids 34 which interact with corresponding positioning aids 34 (here: elevations or depressions) on the opposite end faces 11, 12 of segments of another claw pole stator 1 disposed so as to be adjacent are provided on the end faces 11, 12 of the segments 3.

The contact faces 13, 14 extend so as to meander between a first radius 16 and a second radius 17 along the radial direction 10.

The poles 19 in the radial direction 6 are disposed outside the contact faces 13, 14.

One contact face 13, 14 is provided on each lateral face 8, 9 of the segment 3. The contact face 13, 14 comprises a partial face of the lateral face 8, 9. The contact faces 13, 14 extend in each case across the entire extent of the lateral face 8, 9 along the axial direction 10. The contact faces 13, 14 extend only across part of the extent of the lateral face 8, 9 along the radial direction 6.

The contact faces 13, 14 extend so as to meander along the radial direction 6, wherein the form-fitting connection 15 to a segment 3 which is disposed so as to be adjacent is formed by the meandering shape of the contact faces 13, 14. The contact faces 13, 14 along the meandering profile have a smallest curvature radius 18.

The contact faces 13, 14 along the meandering profile here have an exclusively curved profile. No rectilinear regions of the contact faces 13, 14 are thus provided in the radial direction 6 here. That is to say that each point of the contact faces 13, 14 along the radial direction 6 is formed by a curvature radius 18 (variable along the radial direction 6).

The contact faces 13, 14 along the meandering profile extend across a length 20 which is larger by a factor than a spacing 21 between the first radius 16 and the second radius 17 along the radial direction 6. As a result of the meandering profile, the contact faces 13, 14 are thus extended in length in the radial direction 6 (in comparison to a rectilinear profile between the first radius 16 and the second radius 17 along the radial direction 6) and are thus enlarged.

FIG. 4 shows a claw pole stator 1 in a perspective view. FIG. 5 shows the claw pole stator 1 as per FIG. 4 in a view from below along the axial direction 10. FIGS. 4 and 5 will be conjointly described hereunder. Reference is made to the explanations pertaining to FIGS. 1 to 3.

The claw pole stator 1 is formed by a multiplicity of segments 3 illustrated in FIGS. 1 to 3, said segments 3 being disposed next to one another along a circumferential direction 4 forming the annular claw pole stator 1. Each segment 3, proceeding from an internal circumferential face 5, along a radial direction 6 extends to an external circumferential face 7 and in the circumferential direction 4 is delimited by a first lateral face 8 and a second lateral face 9, and in an axial direction 10 is delimited by a first end face 11 and a second end face 12. Each segment 3 by way of the lateral faces 8, 9 is connected to further segments 3 so as to form the annular claw pole stator 1. Segments 3 disposed so as to be mutually adjacent contact one another by way of a first contact face 13 of the first lateral face 8, or by way of a second contact face 14 of the second lateral face 9, of the respective segment 3 (cf. also FIGS. 1 to 3) and by way of the contact faces 13, 14 configure a connection 15 which is form-fitting in the circumferential direction 4.

The poles 19 in the radial direction 6 are disposed outside the contact faces 13, 14.

Here, all segments 3 are embodied so as to be mutually identical such that the first segment 3 by way of the first contact face 13 thereof contacts the second segment 3 by way of the second contact face 14 thereof. The same then applies in an analogous manner to the other second lateral face 9 of the first segment 3 and to the second contact face 14 disposed thereon.

The claw pole stator 1 is configured so as to be encircling in the circumferential direction 4 and as a largest nominal diameter has a largest first diameter 29, wherein the claw pole stator 1 as a result of the first clearance 24 (cf. FIG. 7) is deformable such that a largest second diameter 30 (indicated in FIG. 5) of the deformed claw pole stator 1 deviates from the first diameter 29 by a minimum dimension.

FIG. 6 shows the segment 3 as per FIGS. 1 to 3 in a view from above along the axial direction 10. Reference is made to the explanations pertaining to FIGS. 1 to 5.

The larger first clearance 24 enables that a lower requirement can be set in terms of the tolerance of the segments 3 in the production of the segments 3. A first tolerance 41 in terms of the circumferential direction 4 can thus be enlarged in comparison to the second tolerance 42 in terms of the radial direction 6.

FIG. 7 shows a form-fitting connection 15 of two segments 3 of the claw pole stator 1 as per FIGS. 4 and 5, in a view from below along the axial direction 10. FIG. 8 shows a form-fitting connection 15 of two segments 3 of another claw pole stator 1 in a view from below along the axial direction 10. FIGS. 7 and 8 will be conjointly described hereunder. Reference is made to FIGS. 1 to 6.

As can be seen, the poles 19 of the other claw pole stator 1 are disposed on an internal circumferential face 5 of each segment 3.

The first clearance 24 between the adjacent segments 3 enables a mutual relative displacement of the segments 3 along the circumferential direction 4. The second clearance 25 between the adjacent segments 3 enables a smaller mutual relative displacement of the segments 3 along the radial direction 6.

Both claw pole stators 1 are configured so as to be encircling in the circumferential direction 4 and as a largest nominal diameter have a largest first diameter 29, wherein the claw pole stator 1 as a result of the first clearance 24 is deformable such that a largest second diameter 30 of the deformed claw pole stator 1 deviates from the first diameter 29. It is illustrated in FIG. 8 that the second diameter 30 in the case of pulled-apart segments 3 is larger than the first diameter 29.

As a result of the segments 3 being pulled apart or pushed together, and of adjusting a second diameter 30, the annular claw pole stator 1 can be more easily disposed on a stator carrier 32, for example be pushed on along an axial direction 10, for example while assembling the claw pole stator 1 or a stator assembly 31, respectively. The nominal diameter of the claw pole stator 1 upon the push-fitting or the disposing of the latter is then predefined by the stator carrier 32, for example, on which the claw pole stator 1 is then disposed, optionally without a clearance or a gap, respectively, by varying the first clearance 24.

A contact face 13, 14 in the region of the second clearance 25 runs substantially along the circumferential direction 4 and here parallel to the axial direction 10 and transversely to the radial direction 6.

A contact face 13, 14 in the region of the first clearance 24 runs substantially along the radial direction 6 and here parallel to the axial direction 10 and transversely to the circumferential direction 4.

A gap 33 arising, for example as a result of the first clearance 24, between the contact faces 13, 14 of two adjacent segments 3 can be filled by an at least electromagnetically conducting first material 35.

FIG. 9 shows an illustration of a magnetic flux 43 through a fragment of a claw pole stator 1 as per FIG. 8, in a view of the claw pole stator 1 from below along the axial direction 10 (thus viewed from the base area 22, or from the second end face 12, respectively). FIG. 10 shows a detail of FIG. 9. FIG. 11 shows a detail of FIG. 10. FIGS. 9 to 11 will be conjointly described hereunder. Reference is made to the explanations pertaining to FIGS. 1 to 8.

The flow direction 44 of the magnetic flux 43 through the claw pole stator 1 in the operation of the transverse flux machine 2 is illustrated in FIGS. 9 to 11. As can be seen, the flow direction 44 in the region of the contact faces 13, 14 and of the form-fitting connection 15 of the segments 3 runs primarily along the radial direction 6.

In the proposed disposal of the first clearance 24 (effective in the circumferential direction 4) and the smaller second clearance 25 (effective in the radial direction 6) it can be taken into account that only minor gaps 33 result between adjacent segments 3 in those regions that are passed through by the magnetic flux 43. To be taken into account here is the profile (the flow direction 44) of the magnetic flux 43 that arises in the operation of the claw pole stator 1.

It is highlighted in FIG. 11 that contact faces 13, 14 in the region of the second clearance 25 run substantially along the circumferential direction 4 and here parallel to the axial direction 10 and transversely to the radial direction 6. The only minor second clearance 25 ensures that no gaps 33, or only very small gaps 33, arise in these regions such that the magnetic flux 43 can be directed from one segment 3 to another segment 3 ideally without losses.

FIG. 12 shows a sectional illustration of a first variant of embodiment of a stator assembly 31 in a lateral view. FIG. 13 shows a sectional illustration of a second variant of embodiment of a stator assembly 31 in a lateral view. FIGS. 12 and 13 will be conjointly described hereunder. Reference is made to the explanations pertaining to FIGS. 1 to 8.

The stator assembly 31 comprises a plurality of (here six) claw pole stators 1, wherein a coil 40 that runs in the circumferential direction 4 is in each case disposed between two claw pole stators 1 which contact one another by way of the first end faces 11 thereof, the poles 19 of said two claw pole stators 1 being disposed next to one another along the circumferential direction 4 and here so as to mutually overlap in the axial direction 10. The stator assembly 31 furthermore comprises a stator carrier 32 on which the claw pole stators 1 are disposed. The stator carrier 32 predefines a nominal shape of the claw pole stators 1 in terms of an internal diameter (the latter extending between the internal circumferential face 5 of the claw pole stators 1). The claw pole stators 1 are pushed onto the stator carrier 32 as per FIG. 12 along the axial direction 10. To this end, the stator carrier 32 has a purely cylindrical external shape, the internal circumferential face 5 of the claw pole stators 1 bearing on said purely cylindrical external shape.

It is illustrated in FIG. 13 that the stator carrier 32 on a first end 38 and on a second end 39, proceeding from the otherwise cylindrical external shape, in the radial direction 6 has in each case outwardly extending shoulders 37. As a result of these shoulders 37, it is impossible for the claw pole stators 1 to be pushed on along the axial direction 10 when said claw pole stators 1 have a nominal shape. As a result of the first clearance 24, the individual segments 3 can now be pulled apart such that the claw pole stator 1 has an enlarged second diameter 30. The claw pole stators 1 in this state can be pushed onto the stator carrier 32 along the axial direction 10, even across the shoulder 37.

FIG. 14 shows the stator assembly 31 as per FIG. 12 in a sectional perspective view. FIG. 15 shows the stator assembly 31 as per FIGS. 12 and 14 in a perspective view. FIG. 16 shows the stator assembly 31 as per FIGS. 12, 14 and 15, here having a second material 36, in a perspective view. FIGS. 14 to 16 are conjointly described hereunder. Reference is made to the explanations pertaining to FIGS. 12 and 13.

The stator assembly 31 comprises the six claw pole stators 1, wherein a coil 40 that runs in the circumferential direction 4 is in each case disposed between two claw pole stators 1. The stator assembly 31 furthermore comprises a stator carrier 32 on which the claw pole stators 1 are disposed.

In the state according to FIGS. 12 to 15, a first material 35 can in particular be disposed such that potentially present gaps 33 between the contact faces 13, 14 of the segments can be filled with the first material 35.

It is illustrated in FIG. 16 that the claw pole stators 1, or the segments 3, respectively, are at least partially encompassed by a second material 36 such that a nominal shape of the claw pole stators 1 is set by the second material 36. The second material 36 during the application is in particular of low-viscosity or liquid such that even small voids in the claw pole stator 1, for example between the coil 40 and the segments 3, can be filled as a result.

A transverse flux machine 2 known from WO 2018/166858 A1 is indicated in FIG. 16. The transverse flux machine 2 comprises inter alia a stator 26 and a rotor 27, wherein the stator 26 here comprises six of the claw pole stators 1. Two claw pole stators 1 are in each case disposed next to one another along the axial direction 10, wherein said claw pole stators 1 contact one another by way of the first end faces 11, wherein the poles 19 of two claw pole stators 1 along the circumferential direction 4 are in each case disposed in an alternating manner and in each case so as to be mutually adjacent, and in the axial direction 10 are disposed so as to mutually overlap. The claw pole stators 1 here are mutually disposed such that the poles 19, proceeding from the base area 22, along the axial direction 10 extend to the other claw pole stator 1. One coil 40 is in each case disposed between these claw pole stators 1.

The axial direction 10 is aligned so as to be parallel to a rotation axis 32 of the transverse flux machine 2.

The rotor 27 extends in an annular manner and along the circumferential direction 4 has a multiplicity of permanent magnets 45, wherein an air gap encircling in the circumferential direction 4 is provided between the rotor 27 and the stator 26.

### LIST OF REFERENCE SIGNS

1 Claw pole stator
2 Transverse flux machine
3 Segment
4 Circumferential direction
5 Internal circumferential face
6 Radial direction
7 External circumferential face
8 First lateral face
9 Second lateral face
10 Axial direction
11 First end face
12 Second end face
13 First contact face
14 Second contact face
15 Connection
16 First radius
17 Second radius
18 Curvature radius
19 Pole
20 Length
21 Spacing
22 Base area
23 Taper
24 First clearance
25 Second clearance
26 Stator
27 Rotor
28 Rotation axis
29 First diameter
30 Second diameter
31 Stator assembly
32 Stator carrier
33 Gap
34 Positioning aid
35 First material
36 Second material
37 Shoulder
38 First end
39 Second end
40 Coil
41 First tolerance
42 Second tolerance
43 Magnetic flux
44 Flow direction
45 Permanent magnet

1. A claw pole stator for a transverse flux machine, wherein the claw pole stator is formed by a multiplicity of segments which are disposed next to one another along a circumferential direction; wherein each segment, proceeding from an internal circumferential face, along a radial direction extends to an external circumferential face and in the circumferential direction is delimited by a first lateral face and a second lateral face, and in an axial direction is delimited by a first end face and a second end face; each segment by way of the lateral faces is connected to at least one further segment, wherein segments disposed so as to be mutually adjacent contact one another by way of a first contact face on the first lateral face or by way of a second contact face on the second lateral face and by way of the contact faces configure a connection which is form-fitting in the circumferential direction and in the radial direction; wherein a first clearance of the connection, present in the circumferential direction, is larger than a second clearance of the connection, present in the radial direction.

2. The claw pole stator as claimed in claim 1, wherein the second clearance is at most 50% of the first clearance.

3. The claw pole stator as claimed in claim 1, wherein the claw pole stator is configured so as to be encircling in the circumferential direction, and as a largest nominal diameter has a largest first diameter, wherein the claw pole stator as a result of the first clearance is deformable such that a largest second diameter of the deformed claw pole stator deviates from the first diameter by at least 2%.

4. The claw pole stator as claimed in claim 1, wherein each segment comprises a plurality of poles.

5. The claw pole stator as claimed in claim 1, wherein each segment has exactly one pole.

6. The claw pole stator as claimed in claim 1, wherein each of the segments is produced by powder metallurgy by pressing and heat-treating.

7. The claw pole stator as claimed in claim 1, wherein the claw pole stator is formed exclusively by identically embodied segments.

8. The claw pole stator as claimed in claim 1, wherein the segments at least conjointly with the external circumferential face or the internal circumferential face of the segments form a cylindrical contour, wherein a circumferential face of the external circumferential face and the internal circumferential face is formed by the poles of the segments.

9. A stator assembly, at least comprising a claw pole stator as claimed in claim 1 and a stator carrier, wherein the claw pole stator is disposed on the stator carrier, the latter at least in terms of an internal diameter or an external diameter of the claw pole stator predefining a nominal shape of the claw pole stator.

10. The stator assembly as claimed in claim 9, wherein a gap between at least two segments is at least partially filled by an at least electromagnetically conducting first material.

11. The stator assembly as claimed in claim 9, wherein the segments are at least partially encompassed by a second material such that a nominal shape of the claw pole stator is set by the second material.

12. A segment for a claw pole stator as claimed in claim 1, wherein the segment, proceeding from an internal circumferential face, along a radial direction extends to an external circumferential face, and in a circumferential direction is delimited by a first lateral face and a second lateral face, and in an axial direction is delimited by a first end face and a second end face; wherein the segment by way of the lateral faces is able to be connected to at least one further segment; wherein segments which are able to be disposed so as to be mutually adjacent contact one another by way of a first contact face of the first lateral face or by way of a second contact face of the second lateral face; wherein the contact faces are shaped such that a connection, which is form-fitting in the circumferential direction, to a contact face shaped in a complementary manner of a segment, the latter being able to be disposed so as to be adjacent, is in each case able to be configured by way of the contact faces.

13. The segment as claimed in claim 12, wherein at least one of the contact faces extends so as to be parallel to the axial direction.

14. A transverse flux machine, at least comprising a stator and a rotor, wherein the stator comprises at least two claw pole stators as claimed in claim 1, wherein poles of the first claw pole stator and poles of the second claw pole stator are disposed in an alternating manner and in each case mutually adjacent along the circumferential direction, and disposed so as to mutually overlap in the axial direction.
